(19) United States
(12) Patent Application Publication
(10) Pub. No.: US 2026/0187059 A1
(43) Pub. Date: Jul. 2, 2026

(54) TOPOLOGY-BASED STRUCTURE QUERY LANGUAGE (SQL) CONVERSION

(71) Applicant: T-Mobile USA, Inc., Bellevue, WA (US)

(72) Inventors: Kiranpal Singh Chaggar, Bellevue, WA (US); Ramesh Josyula, Redmond, WA (US); Lance Paul Lukens, Paso Robles, CA (US); Wesley Holmes Rich, De Soto, KS (US); Shawn Wallace, Frisco, TX (US); Chad Allen Yarmer, Fort Collins, CO (US)

(21) Appl. No.: 19/007,021

(22) Filed: Dec. 31, 2024

(51) Int. Cl. G06F 16/2452; G06F 16/21; G06F 16/22

(52) U.S. Cl. CPC G06F 16/24522; G06F 16/211; G06F 16/2228

(57) ABSTRACT

Methods, devices, and systems related to topology-based text-to-SQL conversion techniques are disclosed. In one example aspect, a method for a database query service includes receiving, from a user, a question associated with a network, determining topology information of a subset of network elements based on the question, determining a topology graph based on the topology information and schema information of one or more databases associated with the subset of network elements, retrieving database structural information according to the topology graph associated with the subset of network elements, and converting the question into one or more structured query language (SQL) queries based on the database structural information.

### BACKGROUND

Structured Query Language (SQL) is a domain-specific language used to manage data in relational database management systems (RDBMSs). It is particularly useful in handling structured data, such as data incorporating relations among entities and variables.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates Fifth Generation (5G) core network functions (NFs) that can implement aspects of the present technology.

FIG. 3A illustrates an example topology for macro cells in accordance with one or more embodiments of the present technology.

FIG. 3B illustrates an example topology for micro cell(s) in accordance with one or more embodiments of the present technology.

FIG. 3C illustrates an example topology for non-terrestrial cells in accordance with one or more embodiments of the present technology.

FIG. 4 illustrates an example mapping of the network topology to respective database schemas in accordance with one or more embodiments of the present technology.

FIG. 5 illustrates a diagram of an example text-to-SQL service in accordance with one or more embodiments of the present technology.

FIG. 6 is a flow chart representation of a method for a query service in accordance with one or more embodiments of the present technology.

FIG. 7 is a block diagram of an example transformer in accordance with one or more embodiments of the present technology.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

SQL is a complex language that requires an understanding of databases and metadata. Today, generative Artificial Intelligence (AI) can enable people without SQL knowledge to query databases by converting texts to SQL queries. This generative AI task is referred to as text-to-SQL, which generates SQL queries from natural language processing (NLP) and converts text into semantically correct SQL.

While existing text-to-SQL techniques have made significant progress, they still face several shortcomings. Many text-to-SQL systems struggle with handling complex database structures, such as joins and aggregations of database tables, leading to incorrect or suboptimal SQL queries. Many systems lack the ability to understand the context of a query, especially when the query is part of a longer conversation. Text-to-SQL models often require large amounts of domain-specific training data, which may not be readily available. In particular, understanding and mapping the natural language query to the correct database schema is complex, especially for databases with intricate and extensive schemas. Providing meaningful feedback to users when a query fails or produces incorrect results is also an area needing improvement.

This patent document discloses techniques that can be implemented in various embodiments to enable handling of complex database structures/schemas, in the context of wireless communication and core networks, for accurate text-to-SQL conversions. The disclosed techniques leverage topology information in communication networks to provide a better understanding of the relationships of database schemas in connection with the various network nodes. Using the disclosed techniques, the generated queries can include different database table columns that correspond to the same semantic meaning, thereby leading to more accurate responses to user questions.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

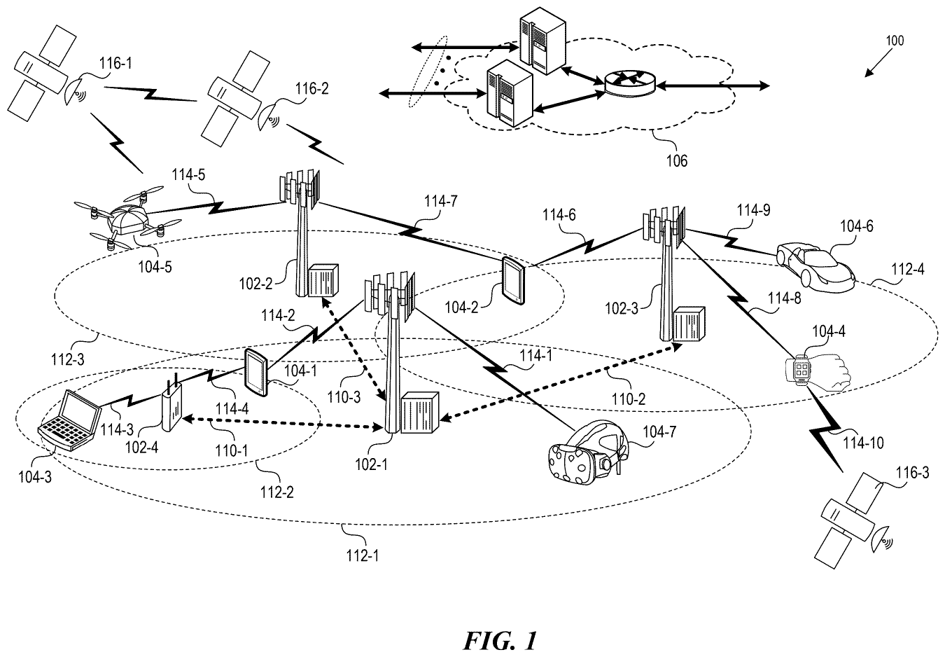

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-3, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

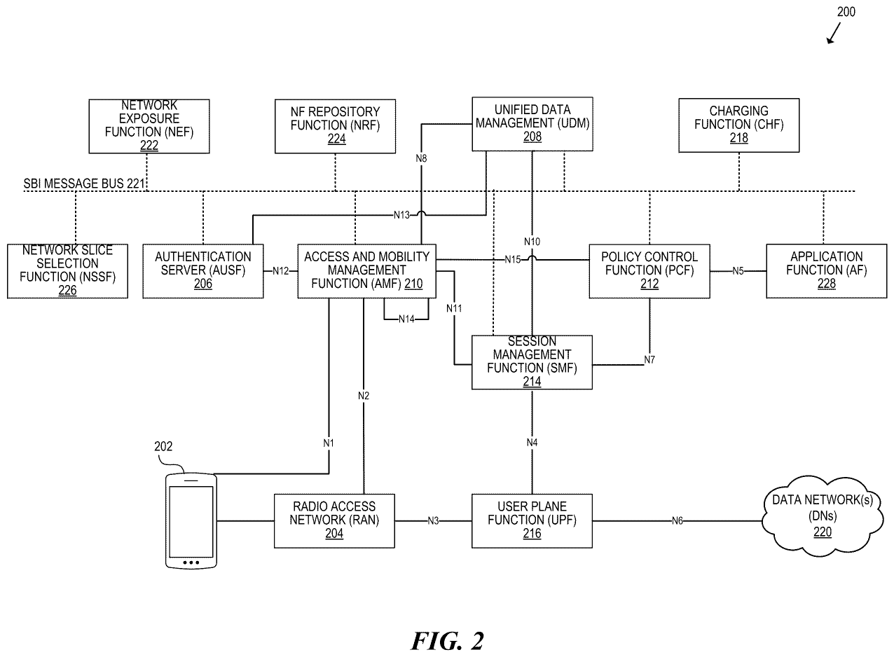

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Topology-Based Text-to-SQL

In a wireless communication network, different network nodes are connected to different databases that have different schemas. The same or similar information may be represented using different columns/keys in database tables. A better understanding of the relationships between various databases by leveraging network topology and the correspondence between the columns/keys can facilitate the development of accurate responses to textual queries.

Network topology in a network refers to the arrangement of various elements (links, nodes, etc.) in the network. Network topology plays an important role in enhancing text-to-SQL systems for core networks. However, a complete representation of all network elements in the network can be too complex to facilitate the understanding of the database relationships. In some embodiments, a graph representation of the network topology can be created for a subset of network elements based on network element information (e.g., types, identifiers, access technology, bandwidth, and/or frequency bands).

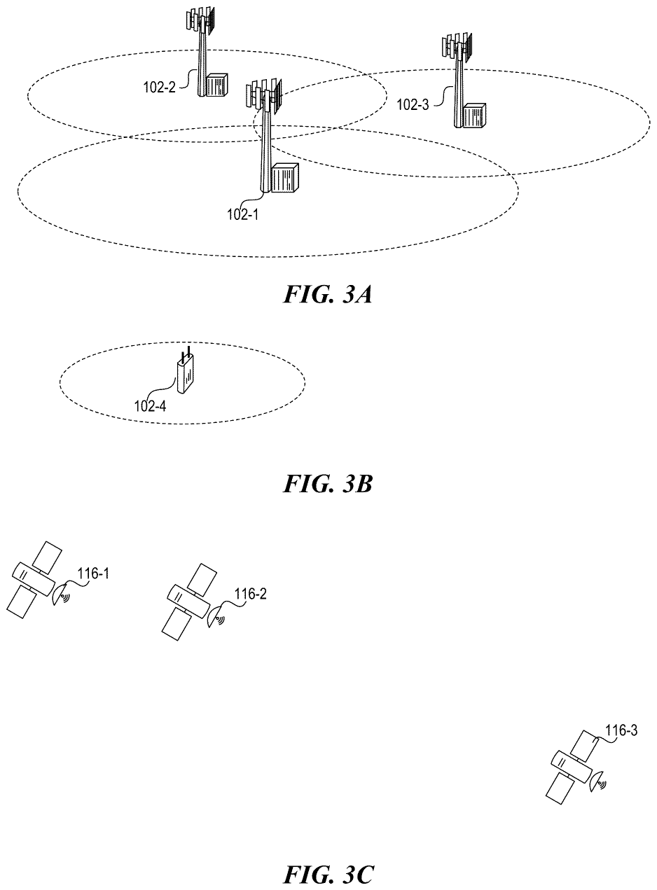

In some embodiments, a topography graph can be created by filtering of the site types (e.g., tower type, antenna height, antenna angles, etc.) and/or locations (e.g., region, market, state, county, city, zip code, etc.). Using access nodes shown in FIG. 1 as an example, different topology graphs can be generated based on the access node/base station types. FIG. 3A illustrates an example topology for macro cells, showing base stations 102-1 to 102-3. FIG. 3B illustrates an example topology for micro cell(s), showing base station 102-4. FIG. 3C illustrates an example topology for non-terrestrial cells 116-1 to 116-3. When a user question is related to a certain cell type (e.g., “how many macro cells are there in total?), the topology graph can be determined according to the cell type. When a user question is related to a certain geographical location (e.g., “how many 5G cells in the Seattle area?”), the topology graph (e.g., topology graph of Seattle) can be determined according to the geographical location.

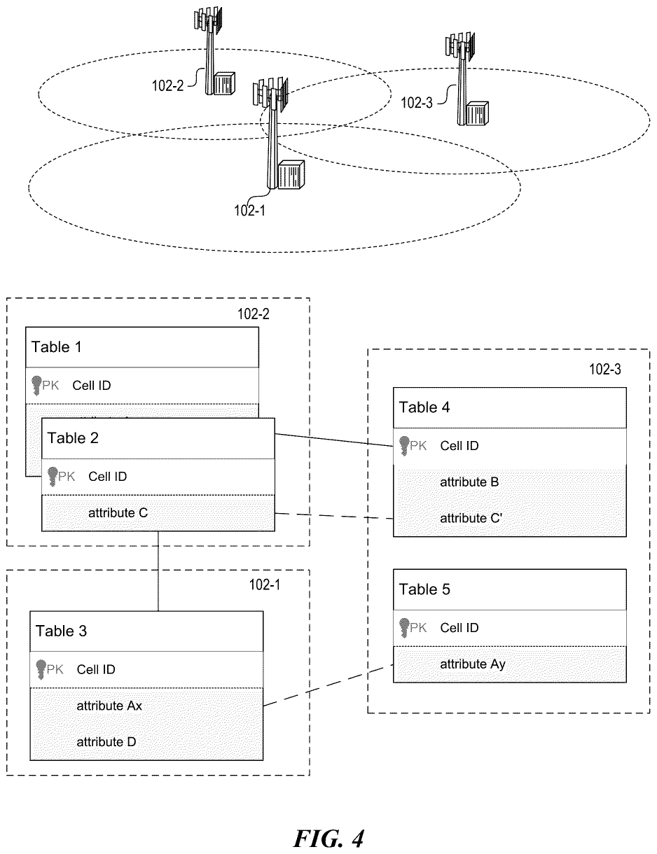

In addition to representing topology information, information associated with database schemas can be used to constructs the graphs, where nodes can represent tables and columns, and edges represent relationships (e.g., foreign keys) among the tables and/or columns. This graph-based representation can help in visualizing complex schemas and understanding the relationships between different entities. In some embodiments, mapping the network topology to the database schemas help understand how different network elements (e.g., routers, switches, servers) are related and how data flows between them. This can help in generating more accurate SQL queries that reflect the network structure. FIG. 4 illustrates an example mapping of the network topology to respective database schemas in accordance with one or more embodiments of the present technology. The graphs constructed based on topology and/or database schemas can provide contextual information about the database schema elements. For example, understanding that certain tables represent network devices and others represent connections can help in accurately mapping natural language queries to the correct schema elements. In some embodiments, schema elements can be supplemented using embedded information based on their position and relationships in the network topology. The embedded information can capture the semantic relationships between different elements, improving the accuracy of query generation. In some embodiments, additional metadata such as column descriptions, data types, and constraints can be embedded to the database schemas to provide more context for the schema elements.

In some embodiments, the topology graph can be used to enhance the understanding of the column types and value keys in database schemas, thereby allowing accurate generations of text-to-SQL queries based on user input. In some embodiments, a machine learning model can be trained, using techniques such as decisions trees, random forests, and/or clustering, to categorize columns into different types. Information can be represented using different schema element names. Grouping of the columns can be based on the understanding of the semantic meaning of the columns. For example, database columns can have different names but are categorized as representing the same information. Column names such as “Tower,” “Antenna,” and/or “Tilts” can be grouped together as a type that represents cell site information. Column names such as “Frequency Bands” and/or “Bandwidth” can be grouped together as a type that represents channel information. To query information about the cell site(s), for example, SQL queries can include multiple columns (e.g., “Tower,” “Antenna,” and/or “Tilts”) instead of focusing on only columns that have the word “cell” in the names. As another example, several different database tables can have columns that share the same name, but the content of the database stables correspond to different semantic or contextual meanings that only one database table is relevant to the user-provided queries.

Referring back to FIG. 4, for example, tables can be associated with each other via foreign keys (e.g., referencing the primary key of another table). Tables can also be associated with each other based on the columns, when the columns share the same name or when they share the same semantic meaning with different names (e.g., attribute C and attribute C′; attribute Ax and attribute Ay). The grouping of the columns allows incorporation of relevant columns in the generate queries to improve accuracy of the responses. Table 1 shows another example of leveraging the semantic meaning of the columns. The disclosed techniques allow proper understanding of the term “site” in a user request “in seattle market how many 5G sites?” so that the generated query can include a column of “cell_status” with value “on air” to formulate the response.

TABLE 1
Example Query Generation

{“role”: “user”, “content”: “in seattle market how
many 5G sites? ”} totals from
cellsector_ref where lower(market) = “seattle”
and lower(technology) = “5g” and
lower(cell_status) = “on air””},

In some embodiments, statistical analysis (e.g., isolation forest, z-score) can be performed to identify outlier keys/key values in one or more database tables. For example, a database table may include anomalies that lead to null results. The model can be trained to identify such outliers and/or remove such outliers to reduce the occurrence rate of null responses.

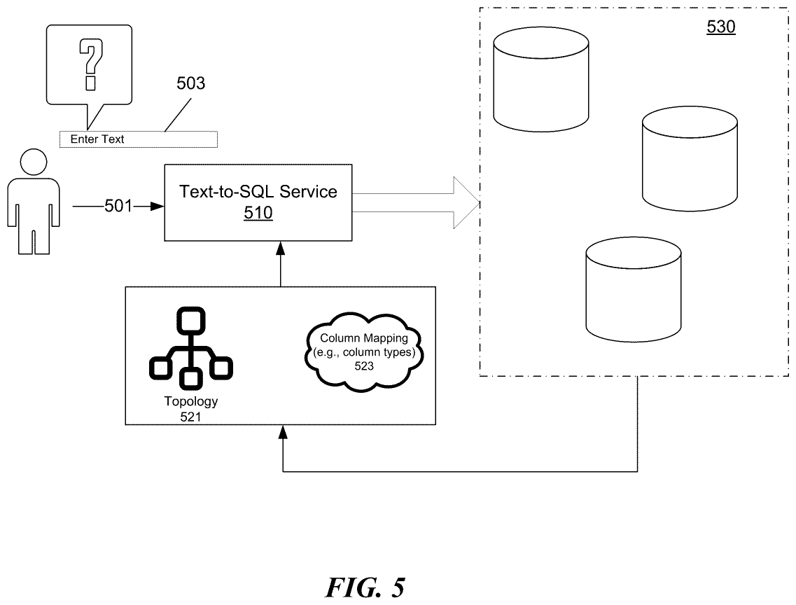

FIG. 5 illustrates a diagram of an example text-to-SQL service in accordance with one or more embodiments of the present technology. As shown in FIG. 5, a user inputs a request or a question 501 to the text-to-SQL service (510) via a user interface 503 (e.g., a webpage with a text input or a chat box). In some implementations, the text-to-SQL service 510 includes one or more machine learning models that are trained using network information, such as topology information 521, to determine the mapping of the databases or database columns 523 (e.g., in the format of topology graphs or in the format of a conventional table of mappings).

In some embodiments, the one or more machine learning models can be trained with a feedback mechanism to improve the accuracy of the determination (e.g., what database tables should be mapped to what type of queries). In some embodiments, the one or more machine learning models can be trained using a configuration file that includes a set of mapping of requests/questions to the database columns and/or database schemas. The configuration table can include manually entered information as an initial training dataset. Table 1 shows an example configuration table in accordance with one or more embodiments of the present technology. The configuration table can include information such as connection settings and the type of SQL dialect to be used (e.g., platform specification), data types and structures expected within the dataset (e.g., dataset specification), the names of the databases relevant to the entry (e.g., database names), the specific tables associated with the entry (e.g., table names), primary and additional keywords associated with the tables' data contexts as well as frequently used words in queries (e.g., keywords), and a prompt identifier (ID) that links the entry to specific prompts or query templates.

TABLE 1

| Platform | Dataset | | | | |
|---|---|---|---|---|---|
| Specification | Specification | Database Names | Table Names | Keywords | ID |
| {“source”: | {“field1”,”type | Network_operations | Network_sites | [words | 1 |
| “db_id”,”SQL | 1”} | | | related to | |
| ”} | | | | network | |
| | | | | sites] | |
| {“source”: | {“field2”,”type | Performance_analysis | Daily_performance | [words | 2 |
| “db_id”,”SQL | 2”} | | | related to | |
| ”} | | | | performance] | |

The configuration table can be updated throughout training and execution. For example, users can be prompted to evaluate the accuracy of a particular response to the question/request. If the user is satisfied with the response, the mapping provided by the one or more machine learning models can be added to the configuration table for subsequent training and/or predictions. Referring to Table 1 above, each user question can be assigned a prompt ID. As more users submit questions, their inputs are added to the configuration table, expanding its knowledge base. This pairing of example questions with corresponding prompt IDs enhances the system's ability to accurately generate queries, thus facilitating a continuous learning cycle.

In some embodiments, a set of non-SQL search queries is generated to retrieve database structural information, such as relevant database tables, schemas, and/or columns from the mapping obtained by the machine learning model(s). The one or more machine learning models then convert the request or the question 501 to one or more SQL queries that are applied on the databases 530. Given the retrieved database structural information, the conversion to the SQL query can be performed using existing text-to-SQL techniques that take in specific database schemas. The text-to-SQL service can also convert the results from the generated SQL queries to natural language(s) to feedback to the user. In some embodiments, the results can be formatted into a user-specified format, such as JSON, XML, and/or HTML.

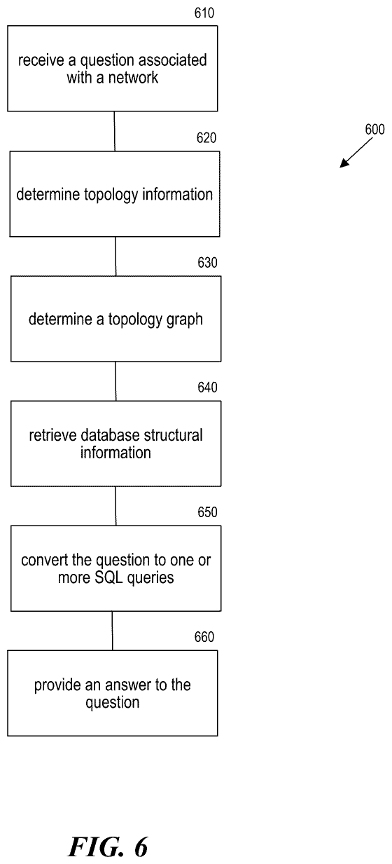

FIG. 6 is a flow chart representation of a method for a query service in accordance with one or more embodiments of the present technology. The method 600 includes, at operation 610, receiving, from a user, a question associated with a network. The method 600 includes, at operation 620, determining topology information of a subset of network elements based on the question. The method 600 includes, at operation 630, determining a topology graph based on the topology information and schema information of one or more databases associated with the subset of network elements. The schema information comprises information about database tables in the one or more databases and relationships among the database tables. The topology graph also comprises information indicating grouping of columns in the database tables according to semantic meanings of the columns. The method includes, at operation 640, retrieving database structural information according to the topology graph associated with the subset of network elements. The method 600 includes, at operation 650, converting the question into one or more structured query language (SQL) queries based on the database structural information. For example, existing text-to-SQL techniques that generate SQL queries given specific database schemas can be used. The method 600 includes, at operation 660, providing a response to the question to the user by applying the one or more SQL queries to the one or more databases and converting the one or more query results to a natural language.

In some embodiments, the topology information is determined based on a location indicated in the question (e.g., “how many base stations in the Seattle area?”). In some embodiments, the topology information is determined based on a cell type indicated in the question (e.g., “how many picocells are there in total?”). In some embodiments, the topology graph is constructed by mapping a network topology associated with the subset of network elements to database schemas of the one or more databases associated with the subset of network elements. In some embodiments, nodes of the topology graph represent tables or columns of the one or more databases associated with the subset of network elements, and edges of the topology graph represent relationships among the one or more databases associated with the subset of network elements.

In some embodiments, the columns are semantically grouped (e.g., Tower,” “Antenna,” “Tilts”) using a machine learning model. In some embodiments, the machine learning model is trained to reduce null responses by identifying anomalies in the schema information of one or more databases.

As shown above, the disclosed techniques can help discern the precise intent behind user questions and can be used to interface with multiple diverse database platforms regardless of the underlying technologies or structures. In some embodiments, feedback loop and intermediate verification steps can be implemented for the one or more machine learning models to ensure correct and refined SQL outputs. The disclosed techniques have demonstrated efficiency and reliability in the generated results, achieving over 96.5% accuracy in Text-to-SQL conversions, a result that is substantially better than existing solutions. The highly accurate results can reduce the need for manual SQL query formulation, thereby minimizing labor time and resources needed for such tasks.

### Machine Learning Models

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publically-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

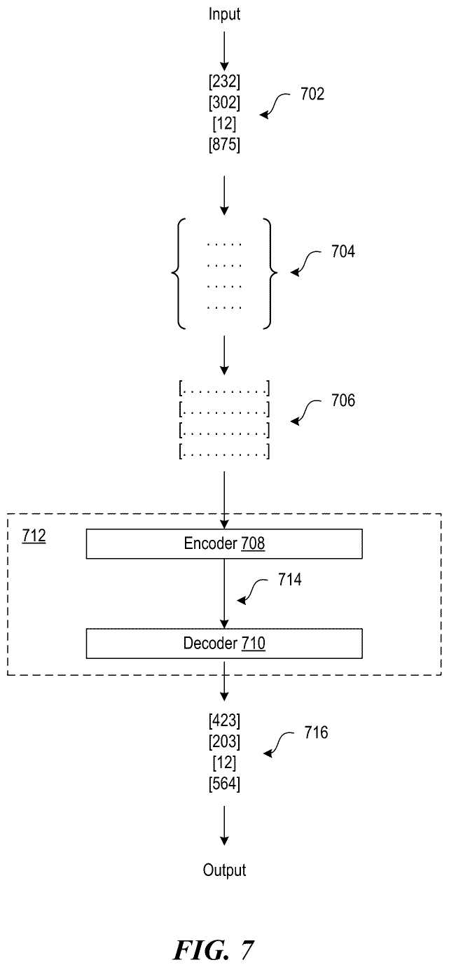

FIG. 7 is a block diagram of an example transformer in accordance with one or more embodiments of the present technology. The example transfer can be used to implement the text-to-SQL conversion based on the topology information as discussed above. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 712 includes an encoder 708 (which can comprise one or more encoder layers/blocks connected in series) and a decoder 710 (which can comprise one or more decoder layers/blocks connected in series). Generally, the encoder 708 and the decoder 710 each include a plurality of neural network layers, at least one of which can be a self-attention layer. The parameters of the neural network layers can be referred to as the parameters of the language model.

The transformer 712 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 712 is trained to perform certain functions on other input formats than natural language input. For example, the input can include objects, images, audio content, or video content, or a combination thereof.

The transformer 712 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 7 illustrates an example of how the transformer 712 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 7, a short sequence of tokens 702 corresponding to the input text is illustrated as input to the transformer 712. Tokenization of the text sequence into the tokens 702 can be performed by some pre-processing tokenization module such as, for example, a byte-pair encoding tokenizer (the “pre” referring to the tokenization occurring prior to the processing of the tokenized input by the LLM), which is not shown in FIG. 7 for simplicity. In general, the token sequence that is inputted to the transformer 712 can be of any length up to a maximum length defined based on the dimensions of the transformer 712. Each token 702 in the token sequence is converted into an embedding vector 706 (also referred to simply as an embedding 706). An embedding 706 is a learned numerical representation (such as, for example, a vector) of a token that captures some semantic meaning of the text segment represented by the token 702. The embedding 706 represents the text segment corresponding to the token 702 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 706 corresponding to the “write” token will be closer to another embedding corresponding to the “jot down” token in the vector space as compared to the distance between the embedding 706 corresponding to the “write” token and another embedding corresponding to the “summary” token.

The vector space can be defined by the dimensions and values of the embedding vectors. Various techniques can be used to convert a token 702 to an embedding 706. For example, another trained ML model can be used to convert the token 702 into an embedding 706. In particular, another trained ML model can be used to convert the token 702 into an embedding 706 in a way that encodes additional information into the embedding 706 (e.g., a trained ML model can encode positional information about the position of the token 702 in the text sequence into the embedding 706). In some examples, the numerical value of the token 702 can be used to look up the corresponding embedding in an embedding matrix 704 (which can be learned during training of the transformer 712).

The generated embeddings 706 are input into the encoder 708. The encoder 708 serves to encode the embeddings 706 into feature vectors 714 that represent the latent features of the embeddings 706. The encoder 708 can encode positional information (i.e., information about the sequence of the input) in the feature vectors 714. The feature vectors 714 can have very high dimensionality (e.g., on the order of thousands or tens of thousands), with each element in a feature vector 714 corresponding to a respective feature. The numerical weight of each element in a feature vector 714 represents the importance of the corresponding feature. The space of all possible feature vectors 714 that can be generated by the encoder 708 can be referred to as the latent space or feature space.

Conceptually, the decoder 710 is designed to map the features represented by the feature vectors 714 into meaningful output, which can depend on the task that was assigned to the transformer 712. For example, if the transformer 712 is used for a translation task, the decoder 710 can map the feature vectors 714 into text output in a target language different from the language of the original tokens 702. Generally, in a generative language model, the decoder 710 serves to decode the feature vectors 714 into a sequence of tokens. The decoder 710 can generate output tokens 716 one by one. Each output token 716 can be fed back as input to the decoder 710 in order to generate the next output token 716. By feeding back the generated output and applying self-attention, the decoder 710 is able to generate a sequence of output tokens 716 that has sequential meaning (e.g., the resulting output text sequence is understandable as a sentence and obeys grammatical rules). The decoder 710 can generate output tokens 716 until a special [EOT] token (indicating the end of the text) is generated. The resulting sequence of output tokens 716 can then be converted to a text sequence in post-processing. For example, each output token 716 can be an integer number that corresponds to a vocabulary index. By looking up the text segment using the vocabulary index, the text segment corresponding to each output token 716 can be retrieved, the text segments can be concatenated together, and the final output text sequence can be obtained.

In some examples, the input provided to the transformer 712 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

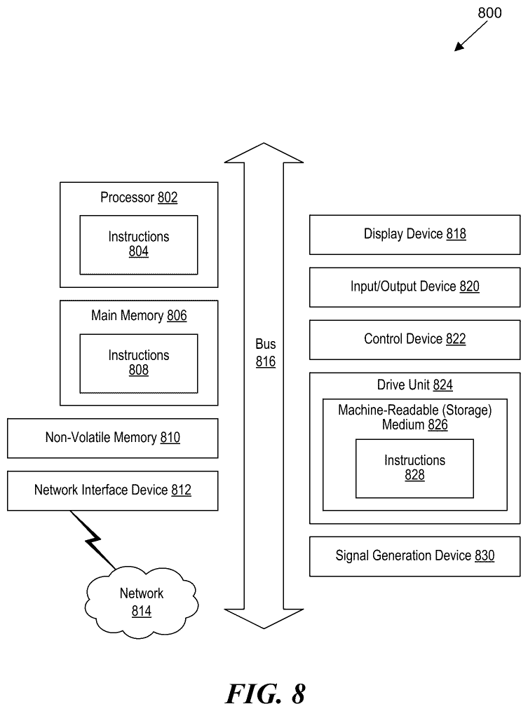

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer system (SBC), or a distributed system such as a mesh of computer systems, or it can include one or more cloud components in one or more networks. Where appropriate, one or more computer systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method for a database query service for a telecommunications network, comprising:
receiving, from a user, a natural language input including a question associated with the telecommunications network,
wherein the telecommunications network includes multiple network elements distributed over a geographical region,
wherein the multiple network elements include one or more of a cell site, a router, a switch, a server, and/or a link, and
wherein the question includes an indication to a first attribute associated with a portion of the network elements in the geographical region;
determining, from the multiple network elements, a subset of the multiple network elements associated with the first attribute;
determining topology information of the subset of network elements based on the question,
wherein the determined topology information for the subset of network elements describes a relative arrangement of the subset of network elements in the geographical region;
determining a topology graph based on the topology information and schema information of one or more databases associated with the subset of network elements,
wherein the schema information comprises information about database tables in the one or more databases and relationships among the database tables,
wherein the database tables include, for each respective network element in the subset of network elements, a column including a network element identifier and one or more attributes associated with the
wherein the topology graph comprises information indicating grouping of columns in the database tables according to semantic meanings of the columns;
retrieving database structural information according to the topology graph associated with the subset of network elements;
converting the question into one or more structured query language (SQL) queries based on the database structural information; and
providing a response to the question to the user by applying the one or more SQL queries to the one or more databases and converting one or more query results to a natural language.

2. The method of claim 1, wherein the first attribute is a location associated with the portion of the network elements and the topology information is determined based on the location.

3. The method of claim 1, wherein the first attribute is a cell type associated with the portion of the network elements and the topology information is determined based on the cell type.

4. The method of claim 1, wherein the topology graph is constructed by mapping, using one or more machine learning models, a network topology associated with the subset of network elements to database schemas of the one or more databases associated with the subset of network elements.

5. The method of claim 4, wherein nodes of the topology graph represent tables or columns of the one or more databases associated with the subset of network elements, and wherein edges of the topology graph represent relationships among the one or more databases associated with the subset of network elements.

6. The method of claim 1, wherein the columns are grouped according to different column types.

7. The method of claim 1, wherein the columns are grouped using a machine learning model.

8. The method of claim 7, wherein the machine learning model is trained to reduce null responses by identifying anomalies in the schema information of the one or more databases.

9. A system for a database query service for telecommunications network, comprising:
a user interface configured to receive a natural language input including a question associated with the telecommunications a network from a user,
wherein the telecommunications network includes multiple network elements distributed over a geographical region,
wherein the multiple network elements include one or more of a cell site, a router, a switch, a server, and/or a link, and
wherein the question includes an indication to a first attribute associated with a portion of the network elements in the geographical region; and
at least one processor that is configured to cause the system to:
determine, from the multiple network elements, a subset of the multiple network elements associated with the first attribute;
determine topology information of the subset of network elements based on the question,
wherein the determined topology information for the subset of network elements describes a relative arrangement of the subset of network elements in the geographical region;
determine a topology graph based on the topology information and schema information of one or more databases associated with the subset of network elements,
wherein the schema information comprises information about database tables in the one or more databases and relationships among the database tables,
wherein the database tables include, for each respective network element in the subset of network elements, a column including a network element identifier and one or more attributes associated with the respective network element, the one or more attributes including the first attribute,
wherein the topology graph comprises information indicating grouping of columns in the database tables according to semantic meanings of the columns;
retrieve database structural information according to the topology graph associated with the subset of network elements;
convert the question into one or more structured query language (SQL) queries based on the database structural information; and
provide a response to the question to the user by applying the one or more SQL queries to the one or more databases and converting one or more query results to a natural language.

10. The system of claim 9, wherein the first attribute is a location associated with the portion of the network elements and the topology information is determined based on the location.

11. The system of claim 9, wherein the topology graph is constructed by mapping a network topology associated with the subset of network elements to database schemas of the one or more databases associated with the subset of network elements.

12. The system of claim 11, wherein nodes of the topology graph represent tables or columns of the one or more databases associated with the subset of network elements, and wherein edges of the topology graph represent relationships among the one or more databases associated with the subset of network elements.

13. The system of claim 9, wherein the columns are grouped according to different column types.

14. The system of claim 9, wherein the columns are grouped using a machine learning model trained to reduce null responses by identifying anomalies in the schema information of the one or more databases.

15. A non-transitory, computer-readable storage medium comprising instructions recorded thereon, wherein the instructions when executed by at least one data processor of a system for a database query service for telecommunications network, cause the system to:
receive, from a user, a natural language input including question associated with the telecommunications network,
wherein the telecommunications network includes multiple network elements distributed over a geographical region,
wherein the multiple network elements include one or more of a cell site, a router, a switch, a server, and/or a link, and
wherein the question includes an indication to a first attribute associated with a portion of the network elements in the geographical region;
determine, from the multiple network elements, a subset of the multiple network elements associated with the first attribute;
determine topology information of thea subset of network elements based on the question,
wherein the determined topology information for the subset of network elements describes a relative arrangement of the subset of network elements in the geographical region;
determine a topology graph based on the topology information and schema information of one or more databases associated with the subset of network elements,
wherein the schema information comprises information about database tables in the one or more databases and relationships among the database tables,
wherein the database tables include, for each respective network element in the subset of network elements, a column including a network element identifier and one or more attributes associated with the respective network element, the one or more attributes including the first attribute,
wherein the topology graph comprises information indicating grouping of columns in the database tables according to semantic meanings of the columns;
retrieve database structural information according to the topology graph associated with the subset of network elements; and
convert the question into one or more structured query language (SQL) queries based on the database structural information.

16. The non-transitory, computer-readable storage medium of claim 15, wherein the instructions further cause the system to:
provide a response to the question to the user by applying the one or more SQL queries to the one or more databases and converting one or more query results to a natural language.

17. The non-transitory, computer-readable storage medium of claim 15, wherein the first attribute is a location associated with the portion of the network elements and the topology information is determined based on the location.

18. The non-transitory, computer-readable storage medium of claim 15, wherein the topology graph is constructed by mapping a network topology associated with the subset of network elements to database schemas of the one or more databases associated with the subset of network elements.

19. The non-transitory, computer-readable storage medium of claim 18, wherein nodes of the topology graph represent tables or columns of the one or more databases associated with the subset of network elements, and wherein edges of the topology graph represent relationships among the one or more databases associated with the subset of network elements.

20. The non-transitory, computer-readable storage medium of claim 15, wherein the columns are grouped according to different column types.
